(19) United States
(12) Patent Application Publication
(10) Pub. No.: US 2023/0396354 A1
(43) Pub. Date: Dec. 7, 2023

(54) Link Adaptation for Frequency Hopped Systems

(71) Applicant: Telefonaktiebolaget LM Ericsson (publ), Stockholm (SE)

(72) Inventors: Leif Wilhelmsson, Lund (SE); Pontus Arvidson, Sollentuna (SE)

(21) Appl. No.: 18/032,255

(22) PCT Filed: Oct. 21, 2021
(86) PCT No.: PCT/EP2021/079262

§ 371 Date: Apr. 17, 2023

Related U.S. Application Data
(60) Provisional application No. 63/105,634, filed on Oct. 26, 2020.

(51) Int. Cl. H04L 1/00; H04L 5/00

(52) U.S. Cl. CPC H04L 1/0003; H04L 5/0012

(57) ABSTRACT

A method of transmission including frequency hopping between channels comprises adjusting modulation and coding scheme for each set of channels for each frequency hop, wherein a set of link adaptation algorithms are used for the adjusting of the modulation and coding scheme. A transceiver comprises a transmitter, a receiver and a controller for controlling the operations of the transmitter and receiver, wherein the controller is arranged to control operations according to the method. A computer program comprises instructions which causes the transceiver to perform the method.

### TECHNICAL FIELD

The present disclosure generally relates to a method of providing link adaptation to a frequency hopping transmission.

### BACKGROUND

Link adaptation (LA) is known to be beneficial for improving the performance of wireless systems when the channel conditions are highly varying. Essentially, the goal of LA is to use the most suitable modulation and coding scheme (MCS) for the present channel conditions. Here most suitable may slightly depend on the supported application, but generally it is the MCS that achieves the highest data rate at a sufficiently low error probability.

LA is used in cellular systems developed by 3GPP, e.g. 3G, 4G, and 5G. It is also a key feature in standards developed by IEEE 802.11, commonly referred to as Wi-Fi. What MCS to select in these systems may e.g. depend on the distance between the transmitter and the receiver, or it may depend on the experienced interference level at the receiver, or a combination of both. The variations in the MCS may correspond to a receiver signal-to-interference-plus-noise-ratio (SINR) in the range of 0-30 dB. 0 dB would in this case typically correspond to that the most robust modulation, typically binary phase shift keying (BPSK) is used together with a low rate error correcting code. 30 dB, on the other hand, may correspond to that several streams can be transmitted in parallel using multiple-input-multiple-output (MIMO), where each stream is modulated using a large modulation alphabet, e.g. 256-quadrature amplitude modulation (QAM) and using an error correcting code of relatively high rate.

For LA to work as intended, the transmitter needs to have accurate information of the receiver conditions in order to select a suitable MCS. Such information may be obtained by explicit feedback from the receiver, or it may be obtained by the transmitter itself by monitoring the success or failure of transmissions using different MCS. The former is typically preferred but comes at a small cost of additional signalling.

Another beneficial feature of almost all wireless systems is frequency diversity. Almost always, the wireless channel between the transmitter and the receiver will have different properties depending on the frequency. Today, many systems use channel bandwidths of at least 20 MHz and sometimes even more than 100 MHz. When this is the case, the channel will vary considerably within the channel bandwidth. The channel is in this case said to be frequency selective. Effectively, when operating over a frequency selective channel, the receiver needs to be more complex as the channel needs to be equalized. However, the performance is also more predictable since the average channel conditions do not fluctuate that much even if the channel at one specific frequency may vary significantly. LA inherently provides the most benefits for varying channel conditions. To give an example, the average SINR over a 20 MHz channel may just vary a few dB while the SINR for the different frequencies within the MHz channel may readily vary by 30 dB or more.

Some wireless systems, however, do use a relatively small channel bandwidth. An example is Bluetooth Low Energy (BLE), where the channel bandwidth is about 1 MHz, depending on how bandwidth is defined. This means that for many typical use cases for BLE, the channel wireless channel will essentially be the same over the channel bandwidth, i.e., the channel can be modelled as a single complex number, and the received signal is the transmitted signal multiplied by this complex number and some additive noise.

In this case the channel is said to be frequency flat, to denote that the entire channel bandwidth experiences the same channel conditions. This means that the signal does not experience any frequency diversity.

A frequency flat channel means that the receiver processing becomes simpler, and that e.g. the reception may be based on simple differential demodulation without the need to perform any channel estimation. A major drawback with a frequency flat channel is that the entire channel may be very bad, i.e., the channel is said to be (flat) fading. As explained above, the channel variations may be 30 dB, and this effectively mean that a system experience flat fading will experience channel variations of 30 dB.

To address the issue that the signal does not experience any frequency diversity, it is commonplace to employ frequency hopping (FH) to obtain frequency diversity. FH means that the frequency is changed so that the channel conditions experienced by the signal will vary depending on what channel is used. The hopping rate (how often the frequency is changed) can be very different for different systems. Historically, when FH was used for very low data rate, fast frequency hopping was a term used to denote that the hopping rate was as fast as the rate of channel coded symbols. So, a single symbol could be represented by sending the information on several different frequencies, effectively achieving frequency diversity on a symbol level. With increased data rate, the hopping rate is typically much lower than the symbol rate. In the classic Bluetooth system, the frequency is changed after each packet (the acknowledgement is also sent on the same frequency). This means that individual packets typically experience very different channel conditions, so that even if one packet experience a bad channel, the next packet (which may be a retransmission of the former packet) may typically experience a completely different channel. FH may be viewed as a means to average out the different channels, such that a system will experience the average (over the bandwidth) conditions, rather than the worst channel conditions (which would be the case without FH is the selected narrowband channel would happen to be the worst channel within the bandwidth). In BLE, frequency hopping is utilized by changing the channel at each connection event, which may be configured to occur with an interval ranging from 7.5 ms to 4 s. The hopping pattern is defined in the specification, and adaptive FH is used by blacklisting channels with poor signal strength or strong interference.

Reflecting on LA and FH, the former can be seen as a means to make optimum use of the channel whereas the latter is a means to just experience the average channel conditions. Also, systems employing FH typically make use of LA, but where the LA is then intended to match the average (over the bandwidth) channel conditions. Essentially, an MCS is selected such that the performance is sufficiently good for at a large majority of the channels used by the FH system.

Efficient LA is based on accurate knowledge of the communication channel, and specifically the receiver conditions. If LA is used for a situation when the receiver conditions vary a lot, it will not work well. Since a system based on FH by design is such the channel ideally should vary depending on what frequency is used for the transmission, applying standard LA to a FH system will in general not work well.

Specifically, the LA will typically try to select the MCS that gives the best overall result, based on the average channel conditions. There are at least two major problems with applying standard LA to a FH system. The first problem is that the achieved performance will typically be far from what is theoretically possible. In particular, the MCSs corresponding to high data rate will not be used, since they will not work well on a relatively large number of channels. The second problem is the behaviour of the LA algorithm itself. Normally the LA algorithm converges to an optimal MCS and is then slightly updated if the channel conditions change. If the system is FH, the LA algorithm will not converge, but will constantly adjust, making the performance almost entirely unpredictable unless the LA algorithm is based on long time averaging, which means the algorithm will react very slowly on channel changes.

The above information disclosed in this Background section is only for enhancement of understanding of the background of the disclosure and therefore it may contain information that does not form the prior art that is already known to a person of ordinary skill in the art.

### SUMMARY

The disclosure is based on the inventors' realization that at least some of the problems demonstrated above may be alleviated with an approach where LA and FH are combined, but where different LA is done for the different channel used for frequency hopping. In this way, the LA algorithms can converge to different MCS for different channels, thus achieving performance relatively close to the theoretical optimum. Since the approach of having many, potentially independent, LA algorithms, means that each LA algorithm will have access to less data for training, it is proposed to base the LA on explicit feedback. For example, the intended receiver may explicitly propose the most suitable MCS, the transmitter may derive a suitable MCS from a response from the receiver, or information about suitable MCS may be derived on other measurements.

According to a first aspect, there is provided a method of transmission including frequency hopping between channels. The method comprises adjusting modulation and coding scheme for each set of channels for each frequency hop, wherein a set of link adaptation algorithms are used for the adjusting of the modulation and coding scheme, and wherein more than one link adaptation algorithm instance are used concurrently.

A set of channels may comprise a single channel, or comprise a plurality of channels adjacent in frequency.

The number of link adaptation algorithm instances of the set of link adaptation algorithms may be the same as the number of channels of the set of channels.

The channels belonging to respective set of channels may be adapted during operation.

The adjusting of modulation and coding scheme may comprise transmitting a first packet on one channel with the most robust available modulation and coding scheme, receiving a response to the first packet, acquiring a suitable modulation and coding scheme for the channel, and adjusting the modulation and coding scheme for a next packet based on the suitable modulation and coding scheme. The acquiring of a suitable modulation and coding scheme may comprise receiving an indication on the suitable modulation and coding scheme in the received response. Alternatively, the acquiring of a suitable modulation and coding scheme may comprise determining a suitable modulation and coding scheme from the received response. The first packet may use a minimum modulation and coding scheme for a used mode of operation.

The method may comprise determining whether a channel is noise limited or interference limited, wherein the adjusting of the modulation and coding scheme may further be based on the determination of the channel limitation.

The method may comprise scanning at least a subset of the sets of channels to determine channel properties, wherein the adjusting of the modulation and coding scheme comprises adjusting based on gained knowledge about the at least a subset of the sets of channels.

The method may comprise omitting use of a set of channels determined to have properties below a first threshold. The first threshold may correspond to a feasibility to use a modulation and coding scheme with a minimum data rate for a used mode of operation.

The method may comprise listing sets of channels having properties reaching a second threshold. The second threshold may correspond to a feasibility to use a modulation and coding scheme with a maximum data rate for a used mode of operation.

A hopping sequence may be based on gained knowledge about channels. A hopping sequence may be based on the result of the scanning of the at least a subset of the channels. The hopping sequence may be determined at each hop. The hopping sequence may be determined at each scanning.

A frequency hopping rate may be adjustable based on the determination of adjusting the modulation and coding scheme. The frequency hopping rate may be determined at each hop. The frequency hopping rate may be determined at an acquisition of new information about the sets of channels. The frequency hopping rate may be determined by hopping to a new channel when a channel in use has properties below a third threshold. The third threshold may correspond to a feasibility to use a target modulation and coding scheme for a used mode of operation. The hopping rate and hopping sequence may be determined such that used sets of channels fulfil the second threshold.

According to a second aspect, there is provided a computer program comprising instructions which, when executed on a processor of a transceiver causes the transceiver to perform the method according to the first aspect.

According to a third aspect, there is provided a transceiver comprising a transmitter, a receiver and a controller for controlling the operations of the transmitter and receiver, wherein the controller is arranged to control operations according to the method according to the first aspect.

Because the LA is individual for the different sets of channels, a suitable MCS will be selected for each of the used channel sets, and the data rates of the selected MCS will typically vary considerable for the different sets of channels. In particular, it will allow for a significant increase in the obtained spectrum efficiency of the system since for channels with favourable conditions very high data rates will be achieved.

### BRIEF DESCRIPTION OF THE DRAWINGS

The above, as well as additional objects, features and advantages of the present disclosure, will be better understood through the following illustrative and non-limiting detailed description of preferred embodiments of the present disclosure, with reference to the appended drawings.

FIG. 1 illustrates an example on how SNR varies for different channels.

FIG. 2 illustrates an example on how symbol error rate varies for different channels.

FIG. 3 illustrates an example on how symbol error rate varies for different channels for a lower MCS.

FIG. 4 illustrates how SNR varies for different channels according to another example.

FIG. 5 illustrates how symbol error rate varies for different channels according to the another example.

FIG. 6 illustrates how symbol error rate varies for different channels for a lower MCS according to the another example.

FIG. 7 illustrates an overview of initial packet exchange to measure, choose and signal MCS according to an example.

FIG. 8 illustrates an overview of initial packet exchange to measure, choose and signal MCS according to another example.

FIG. 9 is a flow chart illustrating methods according to embodiments.

FIG. 10 is a block diagram schematically illustrating a transceiver according to an embodiment.

FIG. 11 schematically illustrates a computer-readable medium and a processing device.

### DETAILED DESCRIPTION

The proposed method applies generally to systems where the used carrier frequency is not expected to be the same for more than a relatively short time, e.g. between 1 ms and 1 s, and where the reason for using more than one carrier frequency is to avoid the situation that a large part of the channel or the entire channel is within a deep fade.

To simplify the description of the disclosure, it will be described for a system employing FH and operating in the 2.4 GHz Industrial Scientific and Medical (ISM) band. Specifically, we assume communication parameters that largely resemble those used in the Bluetooth system, i.e., the channel bandwidth is 1 MHz, the channels are separated by 1 MHz, and in total 79 channels are available and used for FH. The disclosure may equally be applied to BLE, where the channel bandwidth is slightly increased and where the channels are separated by 2 MHz, resulting in a total of 40 channels.

Originally, Bluetooth was based on Gaussian Frequency Shift Keying (GFSK), with a symbol rate of 1 Msymbol/s. The highest data rate was then 1 Mb/s, and lower rates were possible by using error correcting coding. Later, Enhanced Data Rate (EDR) was introduced for increasing the maximum data rate. EDR is based on Differential Phase Shift Keying (DPSK), and comes in two flavours, Differential Quadrature Phase Shift Keying (DQPSK) and Differential 8-Phase Shift Keying (D8PSK). The former has a gross data rate of 2 Mb/s and the latter a gross data rate of 3 Mb/s, and are commonly referred to as EDR2 and EDR3, respectively.

For simplicity, we will assume that the data rates relying on error correcting coding are never used, so that in practice the transmitter will use one of the following modulations
1. GFSK—with a data rate of 1 Mb/s
2. DQPSK—with a data rate of 2 Mb/s
3. D8PSK—with a data rate of 3 Mb/s

To give some numerical values, we will in the provided simulations results use a non-coherent receiver for all the modulation formats. It is well-known that one can do better by trying to generate some kind of phase reference, but this is not relevant for the present disclosure. The disclosure is applicable irrespective of the details of the demodulation.

If we initially assume that the channel within the channel bandwidth (1 MHz) is flat, it can be modelled as an Additive White Gaussian Noise (AWGN) channel. The required signal-to-noise-ratio (SNR), can then for the three different modulations be assumed to be 16, 14, and 19 dB. The fact that the 2 Mb/s mode is better than the 1 Mb/s mode is due to the modulation used, but the result is of course that the 1 Mb/s mode will never be used if EDR is supported. The 3 Mb/s mode EDR3 will be used if the SNR is sufficiently high, otherwise the 2 Mb/s mode EDR2 will be used. This appears to be an extremely simple link adaptation.

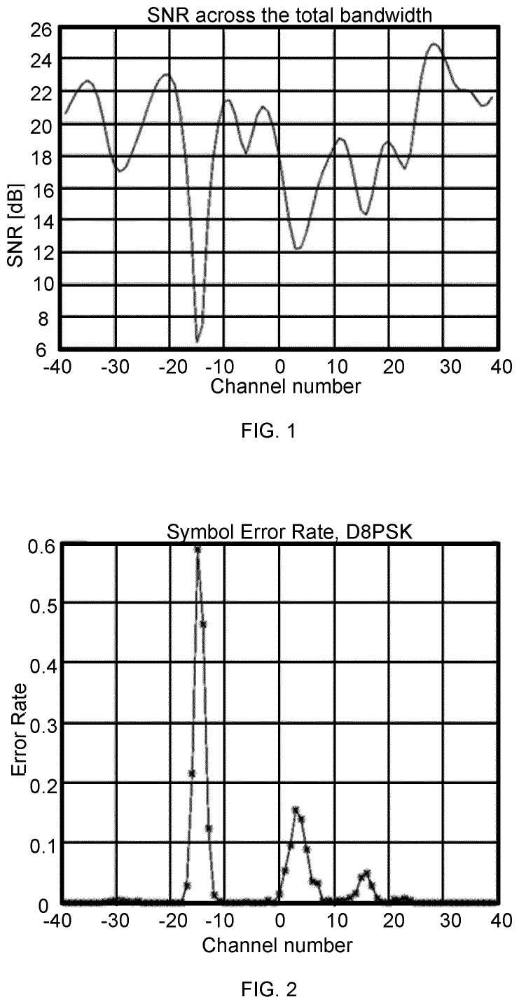

Now consider the fact that Bluetooth uses FH over 79 channels, and that the different channels will attenuate the signal differently. An illustrative example for how the SNR can vary across the 79 channels is depicted in FIG. 1, where the 79 channels are numbered from −39 to 39, with 0 being the channel in the centre.

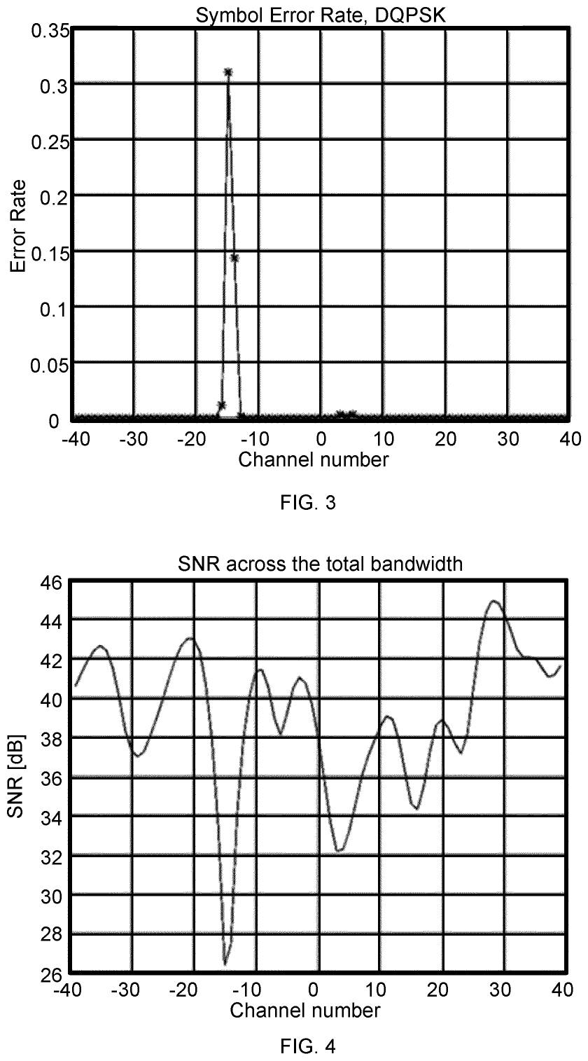

In this simulation, the average SNR is 20 dB, and as can be seen from FIG. 1, the SNR for the different channels vary roughly 20 dB, from 6 dB to 25 dB. Simulating symbol error rate (SER) for the 79 different channels using EDR3 (DQPSK) and EDR2 (DQPSK), the results shown in FIG. 2 and FIG. 3 were obtained.

As can be seen, the results agree quite well with the assumptions that 14 and 19 dB is required for EDR2 and EDR3, respectively.

What is noteworthy is that EDR3 appears to be the preferred modulation for roughly half the channels. For about 35% of the channels, EDR2 is the preferred choice as EDR3 will result in too high SER. For the remaining 15% of the channels, none of the modulations will work. Now, suppose that one does not make a distinction between the different channels, but base the LA on the overall performance. In this case, one could for instance consider which one of EDR2 and EDR3 that gives the highest total throughput by considering the product (Probability of correct bit)*(Number of transmitted bits/symbol). If this is done, EDR3 is found to be the best choice. However, if one instead requires a small probability of error at the expense of lower total throughput, EDR2 is the preferred choice.

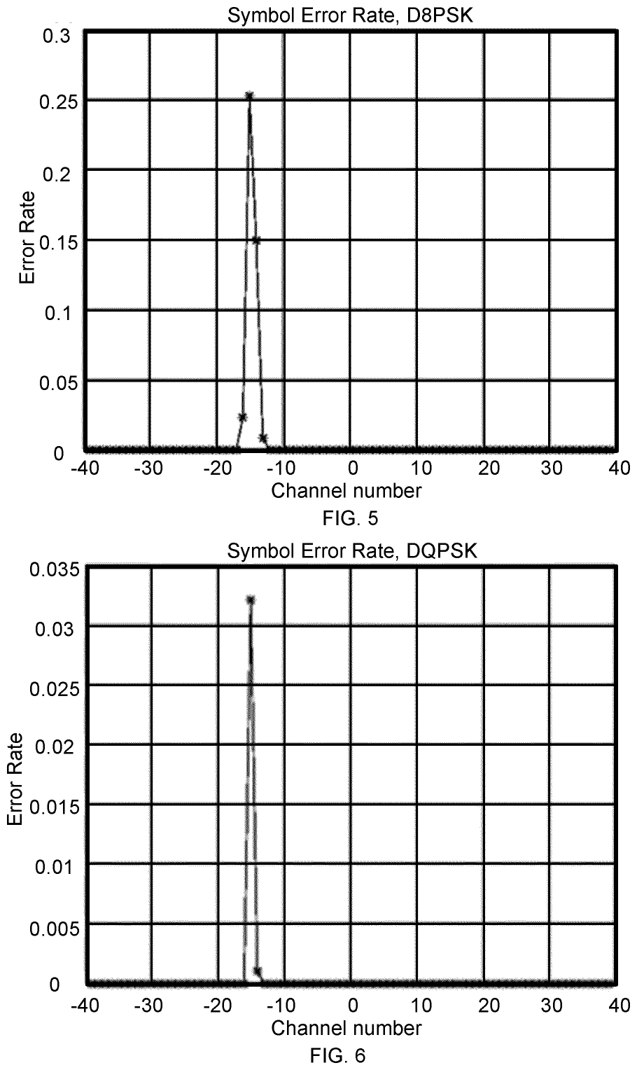

A received SNR of 20 dB would for a Bluetooth system with 1 MHz bandwidth correspond to receiver power of roughly −87 dBm (assuming a noise figure of 7 dB and noting that the terminal noise in a 1 MHz channel is −114 dBm). Simple link budget analysis revel that for many typical use cases, the received power may be considerably higher. Therefore, consider the scenario where the SNR is increased from dB to 40 dB. The corresponding SNR variations and simulated SER are shown in FIGS. 4-6. Referring to FIG. 5 and FIG. 6, both EDR2 and EDR3 will experience errors around channel number −15 in spite of that the SNR is in excess of 26 dB.

The reason for this performance is that the channel experiences a very deep fade at channel number −25 and therefore the amplitude and the phase of the channel will vary considerably within the 1 MHz channel, distorting the signal significantly. Specifically, the assumption of the channel being flat is not valid. In fact, the signal will suffer from inter-symbol-interference (ISI), i.e., the symbols will interfere with one another to some extent.

From the simulation results and the discussion above a number of things can be noted. First, when a FH system is employed, the most suitable MCS will depend on the channel used. Some channels are relatively good, and for these an MCS achieving high data rate can be used, whereas other channels are relatively bad, and for these a more robust MCS should be used, corresponding to a lower data rate.

Second, if a relatively simple receiver is used such that the link on some channels potentially will suffer from ISI, it is not possible to determine the receiver performance only using the SNR at the receiver. In particular if the MCS achieves relatively high data rate, ISI rather than noise may be what limits the performance.

Based on the discussion above, the following embodiments and examples are disclosed for addressing the problems and achieving improved performance.

To address that the different channels in a frequency hopped systems experience highly different channel conditions, this embodiment covers the approach that more than one instance of a link adaptation algorithm is used concurrently. The approach is characterized of that the more than one LA algorithm is updated (active) one at a time, and which one being updated depends on which frequency channel being used for transmission of data.

As one example, in a frequency hopped systems the number of concurrent LA algorithm may be the same as the number of different frequencies used for FH. If for instance 79 channels are used for FH, the number of LA algorithm instances that run in parallel would be 79.

As another example, in order to reduce the complexity, the number of LA algorithms run in parallel could be less than the number of channels used for FH. The number of LA algorithms run in parallel may then be based on an estimate of how much the channel is changing in frequency, i.e., how frequency selective the channel is. As an example, with 79 channels one may use the same LA algorithm for 5 adjacent channels if these are determined to behave somewhat similar, resulting in that in total 16 LA algorithms would be needed for LA of the 79 channels.

Due to that each one of the different channels in a FH system is only used for a small fraction of time, LA algorithms that are based on collecting a large amount of statistical data may therefore not be suitable. Based on this observation, we also disclose ways to perform the actual LA.

To find the most suitable MCS to use, the following approach based on explicit feedback is disclosed. The first packet sent from the transmitter to the intended receiver has the primary purpose that the receiver will be able to determine the most suitable MCS and does not carry any data or carry the smallest amount of data possible (i.e., using the lowest data rate and the shortest possible packet). The by the receiver determined most suitable MCS is reported back to the transmitter, which will use this proposed most suitable MCS in the next transmission. In this way the most suitable MCS can be used already in the second transmission on this channel. For the transmissions following, it can be expected that the channel will only change at a relatively slow rate, and the LA may then either be based on explicit feedback from the receiver or done without explicit feedback where the transmitter may e.g. base the LA on the statistics of ACK/NACK reports.

Also, part of this embodiment is that the receiver in the explicit feedback may indicate whether the link is noise limited or limited by inter-symbol interference.

Due to that that the channels allow for very different performance, it is advantageous to use the best channels, and in particular avoid the worst ones. According to this embodiment, a scanning is performed before starting the actual transmission of the data. As an example, if there in total are 79 available channels, the transmitter may send a packet on each one of these channels and request the receiver to send back information about the quality of these different channels, e.g. by reporting what MCS can be used for the respective channels. If for instance the packet is 100 us in duration and the time for switching frequency is 150 us, 4 channels can be scanned in 1 ms, i.e., the 79 channels may be scanned in 20 ms, which then can be used to find a suitable channel to be used for the actual transmission.

Adaptive FH is a means used in Bluetooth for primarily avoiding interference from Wi-Fi. The idea is that frequencies that are interfered by Wi-Fi will not be used, the frequency hopping patterns is adapted so that these frequencies are not used. Typically, this means that the hopping pattern is updated such that e.g. 20 consecutive channels are not used, corresponding to where the Wi-Fi interference can be found. However, the adaptation of the FH may be for individual frequencies as well. According to this embodiment the AFH is based on the channel quality at the different frequencies, e.g. as described in Embodiment 3.

If the FH system is such that the frequency is changed after each packet transmission, like in the original Bluetooth system, the FH sequence may consist of only those frequency for which the highest data rate is determined to be feasible. Alternatively, the FH sequence may consist of the frequencies for which the two highest data rates are feasible, and then different MCS would be used for the different channels depending on the estimated channel quality as illustrated in FIGS. 1-6.

If the FH system instead uses one channel as long as it is considered sufficiently good, and only change when this condition is not fulfilled, a similar approach would be used, but where the next frequency in the FH sequence is only used when the present frequency is found not to be sufficiently good. This way of performing FH resembles the approach used in BLE.

Although the channel many times is slowly varying, it is typically not completely static. This means that even if one scans the full bandwidth to determine the most suitable channels to use at one instant of time, these channels may no longer have favourable properties when actually needed. To avoid hopping to a channel which in the past was classified as good, but which has changed into being bad, the following approach is disclosed. The approach is primarily intended for the situation when a channel is used as long as it is good, even if it in principle could be used also for the situation when the channel is changed for every transmission.

According to this embodiment, the transmitter keeps an updated list of suitable channels to change to in case the channel currently used for sending data would become bad. The list may consist of a single channel, or several channels to be used in sequence. To keep this updated list, the transmitter uses some of the transmission to perform a scan on a different frequency to determine whether this frequency would be a suitable frequency to change to if needed. As an example, suppose that the transmitter needs to maintain a data stream of 1 Mb/s on average to the receiver. This may e.g. correspond to a streaming application of some kind. By using a suitable channel, it may be possible to transmit at 4 Mb/s so that only 25% of the total capacity needs to be used. The transmitter and receiver may then agree on performing sensing on predetermined frequencies at specific time. The transmitter may for instance transmit a probing packet every 100 ms on a frequency other than the one used for the data transmission to determine whether that frequency would be a suitable candidate to change to in case the channel currently used starts to degrade. The transmitter and the receiver may e.g. agree on a list of 10 candidate frequencies that are probed in according to a predetermined order so that all the 10 candidate frequencies will be probed every second to keep a list of suitable frequencies. As the frequency to change to in case this is needed, the transmitter and the receiver may agree to use the last frequency scanned which was found to be sufficiently good.

For the specific case of a BLE system, the initial transmissions at each connection event may be utilized to gain information on the channel conditions for that specific channel.

The initial transmission of the event, which is always transmitted by a master device, may then include a flag indicating that the packet is intended to probe the channel. This packet would be transmitted using the baseline data rate of 1 Mb/s. Alternatively, if an enhanced data rate mode is used, the baseline data rate could correspond the lowest possible data rate supported by this enhanced mode. The slave device would then respond to the packet with an acknowledgement, allowing the master device to perform channel quality measurements on that transmission, and then selecting the appropriate MCS for subsequent transmissions throughout the connection event. The chosen MCS is indicated to the slave device in the next packet.

Assuming that the extra information needed to convey measurements fits within 2 octets, and that the base 1 MBPS PHY is used, this initial transaction to obtain measurements as well as choose and signal which MCS to use can be completed in 834 μs, allowing for the rest of the current connection event to be used to transmit data at higher rates.

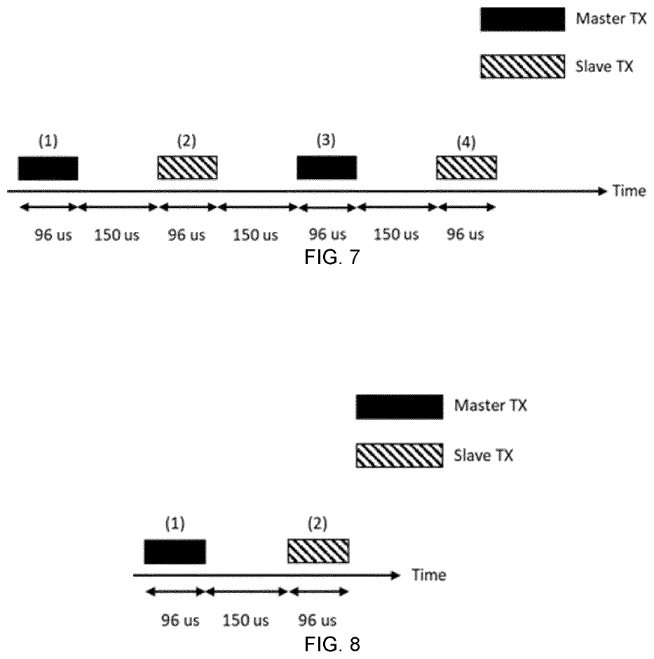

FIG. 7 shows an overview of the initial packet exchange, where (1) is the initial transmission of the connection event, (2) is the acknowledgment from the slave, (3) is the MCS indication packet and (4) is the final ack from the slave. Optionally (2) may also include information on channel conditions obtained by the slave device, by performing measurements on (1), giving the master device additional information for the MCS selection.

If the higher data rata transmission modes are constructed in such a way that the receiver can decode any rate without any previous knowledge about the rate that will be used, the initial packet exchange can be made even shorter. Packets (3) and (4) in FIG. 7 may then be omitted. Alternatively, the approach described above, which is based on explicit feedback, could be used, i.e., the receiver determines the most suitable MCS and sends this information to the master in the response packet. FIG. 8 shows this shorter exchange, where the MCS information may be obtained in only 342 μs.

As mentioned above, the frequency in BLE is changed at every new connection event. Since the quality of the different frequencies can be expected to vary considerably, it would be advantageous if the channels with favourable channels conditions could be used to a larger extent than the channel with less favourable channel conditions. One approach already mentioned is to use AFH, and simply avoid the poor channels. However, in an environment where the channel is changing, what channels are good and what channels are poor will change over time, and AFH may simply be too slow to work as intended. To achieve better use of the channel, i.e., use the good channels to a larger extent the following approach is disclosed, which follows the BLE FH approach with a minor modification. The FH sequence is agreed on before the actual data transmission starts, just like in BLE. However, the duration of a connection interval is not fixed but is allowed to vary from one connection event to the next. Specifically, if the channel is found to be poor, the channel event can be ended, and a new connection event can be started at the next frequency in the FH sequence. On the other hand, if the connection event is using a good channel, the connection event can be extended so that it remains on this frequency as long as the channel is considered sufficiently good.

The change of frequency, i.e., the termination of the connection event may be initiated by any of the devices, indicating that the channel is becoming increasingly worse.

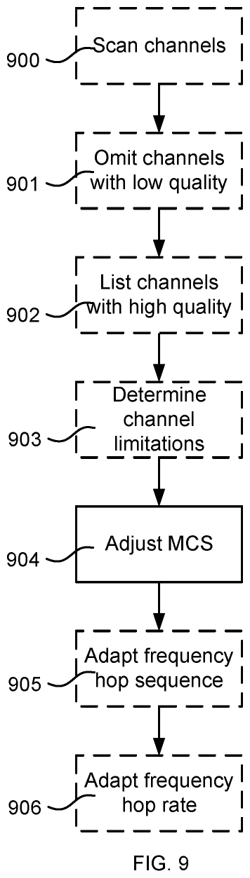

FIG. 9 is a flow chart illustrating methods according to different embodiments. Different options are available and illustrated as dashed boxes. A central feature is to adjust 904 modulation and coding scheme for each set of channels for each frequency hop, wherein a set of link adaptation algorithms are used for the adjusting of the modulation and coding scheme. In essence, a link adaptation algorithm is used for a single channel or a set of channels having correlated properties, e.g. through being at adjacent frequencies. For other channels or sets of channels, other link adaptation algorithms are used. As discussed above, this provides for a better match and tracking of respective channels.

The adjustment 904 of MCS may be based on explicit feedback as discussed above. This can include transmitting a first packet on a channel, e.g. when first using that channel, to get a response from which a suitable MCS, i.e. a starting point for link adaptation, to use is acquired. This can be made by receiving information about the suitable MCS or by determining a suitable MCS based on the reception. The latter relies on reciprocal channel. Knowledge about that channel is thus gained.

According to one option, channels are scanned 900. A subset of available channels, or all available channels are scanned. Knowledge about channel properties is thus gained.

Based on collected knowledge about channels, some of the channels may be considered bad, e.g. having properties below a threshold corresponding to operating at a lowest MCS for a used operation mode, i.e. the most robust available MCS. Such channels may be omitted 901 for further use, at least for some duration.

Based on collected knowledge about channels, some of the channels may be considered good, e.g. having properties reaching a threshold corresponding to operating at a target MCS or even a maximum MCS for a used operation mode. Such channels may be listed 902 for further use, at least for some duration.

From the collected knowledge about channels, it may also be determined 903 whether a channel is noise limited or interference limited. Knowledge about such channel limitation may also be used for adjusting MCS for the channels at frequency hopping.

The frequency hopping itself may also be adjusted. For example, a hop sequence, i.e. what channels to change to when performing a frequency hop, may be adapted 905 based on gained knowledge about channels. For example, known good channels are preferred and known bad channels are avoided. The timing aspect of frequency hopping may additionally or alternatively be adapted 906. The operation may comprise staying on a good, i.e. good and lasting properties, for a longer time while a channel with changing properties is used for a shorter time. In the context of frequency hopping, it is often referred to a “hop rate” which implies a predetermined pace for making frequency hops. However, in this disclosure, the term “hop rate” should be construed in a wider sense and is to be considered as a timing matter which may be variable and adjustable.

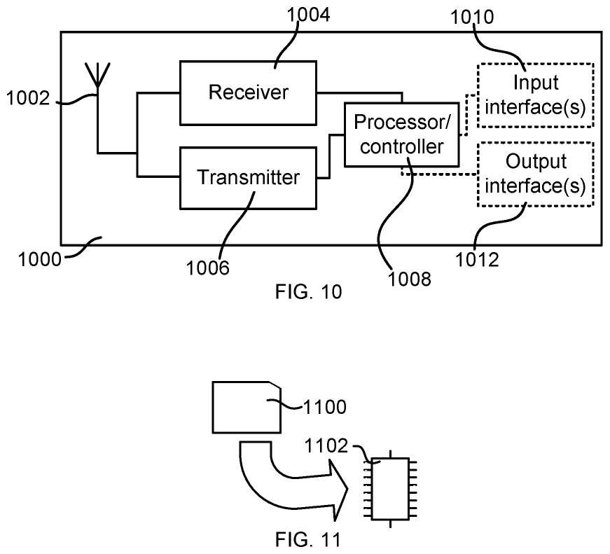

FIG. 10 is a block diagram schematically illustrating a transceiver 1000 according to an embodiment. The transceiver 1000 comprises an antenna arrangement 1002, a receiver 1004 connected to the antenna arrangement 1002, a transmitter 1006 connected to the antenna arrangement 1002, a controller, preferably a processing element, 1008 which may comprise one or more circuits, one or more input interfaces 1010 and one or more output interfaces 1012. The interfaces 1010, 1012 can be user interfaces and/or signal interfaces, e.g. electrical or optical. The transceiver 1000 is arranged to operate in a cellular communication network. In particular, by the processing element 1008 being arranged to perform the embodiments demonstrated with reference to FIGS. 1 to 9, the transceiver 1000 is capable of combining frequency hopping and link adaptation. The processing element 1008 can also fulfil a multitude of tasks, ranging from signal processing to enable reception and transmission since it is connected to the receiver 1004 and transmitter 1006, executing applications, controlling the interfaces 1010, 1012, etc.

The methods according to the present disclosure is suitable for implementation with aid of processing means, such as computers and/or processors, especially for the case where the processing element 1008 demonstrated above comprises a processor handling the frequency hopping and link adaptation. Therefore, there is provided computer programs, comprising instructions arranged to cause the processing means, processor, or computer to perform the steps of any of the methods according to any of the embodiments described with reference to FIG. 1 to 6. The computer programs preferably comprise program code which is stored on a computer readable medium 1100, as illustrated in FIG. 11, which can be loaded and executed by a processing means, processor, or computer 1102 to cause it to perform the methods, respectively, according to embodiments of the present disclosure, preferably as any of the embodiments described with reference to FIGS. 1 to 6. The computer 1102 and computer program product 1100 can be arranged to execute the program code sequentially where actions of the any of the methods are performed stepwise or be performed on a real-time basis. The processing means, processor, or computer 1102 is preferably what normally is referred to as an embedded system. Thus, the depicted computer readable medium 1100 and computer 1102 in FIG. 11 should be construed to be for illustrative purposes only to provide understanding of the principle, and not to be construed as any direct illustration of the elements.

This disclosure may be summarized by the following items:
1. A method of transmission including frequency hopping between channels, the method comprising
adjusting modulation and coding scheme for each set of channels for each frequency hop,
wherein a set of link adaptation algorithms are used for the adjusting of the modulation and coding scheme.
2. The method of item 1, wherein a set of channels comprises a single channel.
3. The method of item 1, wherein a set of channels comprises a plurality of channels adjacent in frequency.
4. The method of any one of items 1 to 3, wherein the number of link adaptation algorithms of the set of link adaptation algorithms is the same as the number of channels of the set of channels.
5. The method of any one of items 1 to 4, wherein the channels belonging to respective set of channels are adapted during operation.
6. The method of any one of items 1 to 5, wherein the adjusting of modulation and coding scheme comprises
transmitting a first packet on one channel with a lowest modulation and coding scheme;
receiving a response to the first packet;
acquiring a suitable modulation and coding scheme for the channel; and
adjusting the modulation and coding scheme for a next packet based on the suitable modulation and coding scheme.
7. The method of item 6 wherein the acquiring of a suitable modulation and coding scheme comprises receiving an indication on the suitable modulation and coding scheme in the received response.
8. The method of item 6 wherein the acquiring of a suitable modulation and coding scheme comprises determining a suitable modulation and coding scheme from the received response.
9. The method of any one of items 1 to 8, comprising determining whether a channel limitation is noise limited or interference limited, wherein the adjusting of the modulation and coding scheme is further based on the determination of the channel limitation.
10. The method of any one of items 6 to 9, wherein the first packet uses a minimum modulation and coding scheme for a used mode of operation.
11. The method of any one of items 1 to 5 comprising
scanning at least a subset of the sets of channels to determine channel properties,
wherein the adjusting of the modulation and coding scheme comprises adjusting based on gained knowledge about the at least a subset of the sets of channels.
12. The method of any one of items 1 to 11 comprising omitting use of a set of channels determined to have properties below a first threshold.
13. The method of item 12, wherein the first threshold corresponds to a feasibility to use a minimum modulation and coding scheme for a used mode of operation.
14. The method of any one of items 1 to 13, comprising listing sets of channels having properties reaching a second threshold.
15. The method of item 14, wherein the second threshold corresponds to a feasibility to use a maximum modulation and coding scheme for a used mode of operation.
16. The method of any one of items 1 to 15, wherein a hopping sequence is based on the result of the scanning of the at least a subset of the channels.
17. The method of item 16, wherein the hopping sequence is determined at each hop.
18. The method of item 16, wherein the hopping sequence is determined at each scanning.
19. The method of any one of items 1 to 18, wherein the frequency hopping rate is adjustable based on the determination of adjusting the modulation and coding scheme.
20. The method of item 19, wherein the frequency hopping rate is determined at each hop.
21. The method of item 19, wherein the frequency hopping rate is determined at an acquisition of new information about the sets of channels.
22. The method of item 19, wherein the frequency hopping rate is determined by hopping to a new channel when a channel in use has properties below a third threshold.
23. The method of item of item 22, wherein the third threshold corresponds to a feasibility to use a target modulation and coding scheme for a used mode of operation.
24. The method of items 15, 17 and any one of items 21, 22 or 23, wherein hopping rate and hopping sequence are determined such that used sets of channels fulfil the second threshold.
25. A computer program comprising instructions which, when executed on a processor of a transceiver causes the transceiver to perform the method according to any one of items 1 to 24.
26. A transceiver comprising a transmitter, a receiver and a controller for controlling the operations of the transmitter and receiver, wherein the controller is arranged to control operations according to the method according to any one of items 1 to 24.

1-26. (canceled)

27. A method of transmission including frequency hopping between channels, the method comprising:
adjusting modulation and coding scheme for each set of channels for each frequency hop; and
wherein a set of link adaptation algorithms are used for the adjusting of the modulation and coding scheme, and wherein more than one link adaptation algorithm instance are used concurrently.

28. The method of claim 27, wherein a set of channels comprises a single channel.

29. The method of claim 27, wherein a set of channels comprises a plurality of channels adjacent in frequency.

30. The method of claim 27, wherein the number of link adaptation algorithm instances of the set of link adaptation algorithms is the same as the number of channels of the set of channels.

31. The method of claim 27, wherein the channels belonging to respective set of channels are adapted during operation.

32. The method of claim 27, wherein the adjusting of modulation and coding scheme comprises:
transmitting a first packet on one channel with the most robust available modulation and coding scheme;
receiving a response to the first packet;
acquiring a suitable modulation and coding scheme for the channel; and
adjusting the modulation and coding scheme for a next packet based on the suitable modulation and coding scheme.

33. The method of claim 32, wherein the acquiring of a suitable modulation and coding scheme comprises receiving an indication on the suitable modulation and coding scheme in the received response.

34. The method of claim 32, wherein the acquiring of a suitable modulation and coding scheme comprises determining a suitable modulation and coding scheme from the received response.

35. The method of claim 27, comprising determining whether a channel is noise limited or interference limited, wherein the adjusting of the modulation and coding scheme is further based on the determination of the channel limitation.

36. The method of claim 32, wherein the first packet uses a most robust available modulation and coding scheme for a used mode of operation.

37. The method of claim 27, comprising:
scanning at least a subset of the sets of channels to determine channel properties; and
wherein the adjusting of the modulation and coding scheme comprises adjusting based on gained knowledge about the at least a subset of the sets of channels.

38. The method of claim 27, comprising omitting use of a set of channels determined to have properties below a first threshold.

39. The method of claim 38, wherein the first threshold corresponds to a feasibility to use a modulation and coding scheme with a minimum data rate for a used mode of operation.

40. The method of claim 27, comprising listing sets of channels having properties reaching a second threshold.

41. The method of claim 40, wherein the second threshold corresponds to a feasibility to use a modulation and coding scheme with a maximum data rate for a used mode of operation.

42. The method of claim 27, wherein a hopping sequence is based on the result of the scanning of the at least a subset of the channels.

43. The method of claim 42, wherein the hopping sequence is determined at each hop.

44. The method of claim 42, wherein the hopping sequence is determined at each scanning.

45. The method of claim 27, wherein the frequency hopping rate is adjustable based on the determination of adjusting the modulation and coding scheme.

46. The method of claim 45, wherein the frequency hopping rate is determined at each hop.

47. The method of claim 45, wherein the frequency hopping rate is determined at an acquisition of new information about the sets of channels.

48. The method of claim 45, wherein the frequency hopping rate is determined by hopping to a new channel when a channel in use has properties below a third threshold.

49. The method of claim 48, wherein the third threshold corresponds to a feasibility to use a target modulation and coding scheme for a used mode of operation.

50. The method of claim 41, wherein hopping rate and hopping sequence are determined such that used sets of channels fulfil the second threshold.

51. A transceiver comprising:
a transmitter;
a receiver; and
control circuitry for controlling operations of the transmitter and receiver, wherein the control circuitry is configured to:
adjust modulation and coding scheme for each set of channels for each frequency hop; and
wherein a set of link adaptation algorithms are used for the adjusting of the modulation and coding scheme, and wherein more than one link adaptation algorithm instance are used concurrently.

52. A non-transitory computer readable medium having instructions stored thereon, wherein the instructions, when executed on control circuitry of a transceiver, causes the transceiver to:
adjust modulation and coding scheme for each set of channels for each frequency hop; and
wherein a set of link adaptation algorithms are used for the adjusting of the modulation and coding scheme, and wherein more than one link adaptation algorithm instance are used concurrently.
